(19) United States
(12) Patent Application Publication
(10) Pub. No.: US 2016/0132871 A1
(43) Pub. Date: May 12, 2016

(54) SECURE REDEMPTION CODE GENERATION FOR GIFT CARDS AND PROMOTIONS

(71) Applicants: Dmitri Bobrovnikoff, Woodside, CA (US); Arjun Satyapal, Mountain View, CA (US); Devin Gormley Carraway, San Francisco, CA (US)

(72) Inventors: Dmitri Bobrovnikoff, Woodside, CA (US); Arjun Satyapal, Mountain View, CA (US); Devin Gormley Carraway, San Francisco, CA (US)

(73) Assignee: GOOGLE Inc., Mountain View, CA (US)

(21) Appl. No.: 13/491,321

(22) Filed: Jun. 7, 2012

(51) Int. Cl. G06Q 20/40; G06Q 20/34

(52) U.S. Cl. CPC G06Q 20/3829; G06Q 20/348; G06Q 2220/00

(57) ABSTRACT

A stored value card management system and method secures against the fraudulent use of stored value cards. A secure redemption code is generated comprising multiple component parts including a look-up identifier and a secure code. The secure redemption code is printed on a face of a stored value card without any visible demarcation of the component parts. The look-up identifier allows access to stored value card records and a determination of the stored value card's activation status. A hash of the secure code is stored in a separate secure index and validation of the secure hash is required to complete redemption of the stored value card. Access privileges to the card index and secure hash index are distinct and possession of one component of the secure redemption code is not sufficient to redeem the stored value card.

### TECHNICAL FIELD

The present disclosure relates generally to systems, methods, and devices for managing and tracking the activation and redemption status of stored value cards, such as gift cards, through the use of a multi-component secure redemption code

### BACKGROUND

Stored value cards, such as gift cards, are a convenient payment option for consumers. A typical stored value card will have a magnetic stripe, a bar code, and a scratch-off code. The magnetic stripe contains a unique identifier for the card. This information is typically also printed as a bar code and as human-readable printed numbers. The scratch-off code contains a secure code hidden behind a scratch-off barrier on the card. This code is needed to complete redemption of the card so that it can be used for payment transactions. Stored value cards are subject to fraudulent use if the secure code is compromised. Compromise of a secure code can occur when an attacker has access to codes before printing, while the card is in the distribution or retail channel, and after purchase. Before a stored value card is used it must be activated; therefore, merely obtaining secure codes is not sufficient to allow fraudulent use. However, after obtaining secure codes an attacker may regularly probe for activation of the card and redeem the associated value before a purchaser does. Alternatively, attackers have been able to utilize a sufficient sample set of secure codes to reverse engineer the algorithm used to generate them, and thereby obtain the ability to generate their own fraudulent but useable secure codes.

### SUMMARY

In certain exemplary aspects, a computer-implemented method for redeeming an activated stored value card comprises the use of a secure redemption code, wherein the secure redemption code comprises at least a look-up identifier component part and a secure code component part. The secure redemption code may further comprise a version number and a checksum value. The component parts are concatenated together and the result encoded to a human readable form prior to printing on a designated area of a stored value card. There is no visible demarcation between the individual component parts when printed. When a stored value card is redeemed, the secure redemption code is communicated to a stored value card management system which parses the secure redemption code into the component parts. The look-up identifier is used to look-up a corresponding card record in a card record index. The card record indicates the card's activation status. If the card is activated, the method proceeds by passing the secure redemption code component part to secure storage system. The secure storage system converts the secure redemption code into a secure version, such as an encrypted version or secure hash version. The secure version of the secure redemption code is then validated by searching a secure code index. If a matching secure version is found in the secure code index, the card record in the card index is updated to indicate the stored value card is redeemed. A stored value card may be used to complete a payment transaction once redeemed.

These and other aspects, objects, features, and advantages of the exemplary embodiments will become apparent to those having ordinary skill in the art upon consideration of the following detailed description of illustrated exemplary embodiments, which include the best mode of carrying out the invention as presently perceived.

### BRIEF DESCRIPTION OF THE DRAWINGS

FIG. 1 is a block diagram depicting a stored value management system according to an exemplary embodiment.

FIG. 2 is a block flow diagram depicting a method for generating a stored value card having a secure redemption code according to an exemplary embodiment.

FIG. 3 is a block flow diagram depicting a method for generating a secure redemption code according to an exemplary embodiment.

FIG. 4 is a block flow diagram depicting a method for activating a stored value card according to an exemplary embodiment.

FIG. 5 is a block flow diagram depicting a method for redeeming an activated stored value card using the secure redemption code according to an exemplary embodiment.

### DETAILED DESCRIPTION OF EXEMPLARY EMBODIMENTS

### Overview

The methods and systems described herein enable the generation of secure redemption codes for eliminating or mitigating fraudulent use of stored value cards. The present invention utilizes a secure redemption code containing multiple component parts including at least a look-up identifier, and a secure code. The look-up identifier and secure code are generated using a cipher and a key, or other high-quality entropy source, such as a cryptographically strong random number generator. The key is generated using a random number generator. The look-up identifier is stored in a stored value card record in a card index. The secure code is communicated to a secure storage system having separate access privileges from other components of the stored value card management system. The secure storage system converts the secure code into a secure storage version and stores the secure storage version in a secure code index within the secure storage system. After printing on a stored value card, the secure code component is not stored in the stored valued card index. A stored card identifier is associated with each stored card record. The look-up identifier, secure code, and any additional component parts, such as a version number, are concatenated in binary form to generate a secure redemption code. The secure redemption code is then encoded into a human readable form and printed on a designated area of a stored value card. A removable barrier, such as a latex barrier, is applied over the secure redemption code.

The stored value card must first be activated by communicating the stored value card identifier to the stored value management system from a point of sale (POS) device at the time of initial purchase. If the communicated card identifier matches a card identifier in the card index, the status of the corresponding record is changed to active. Once activated the monetary value associated with the stored value card can be redeemed and used to complete a payment transaction. When the stored value card is subsequently redeemed, the secure redemption code is communicated to the stored value card management system. The stored value card management system parses the secure redemption code into its component parts. The look-up identifier is used to identify the corresponding card record in the card index and verify that the record's status is active. The secure code component is communicated to the secure storage system and converted into its secure storage version. The secure storage system then verifies whether a matching secure storage version is present in the secure code index. If a matching secure storage version of the secure code is present in the secure code index, a verification is communicated to the POS device or other device initiating the redemption request. The stored value card may then be used to complete a payment transaction.

The inventive functionality of the invention will be explained in more detail in the following description, read in conjunction with the figures illustrating the program flow.

### System Architecture

Turning now to the drawings, in which like numerals indicate like (but not necessarily identical) elements throughout the figures, exemplary embodiments are described in detail.

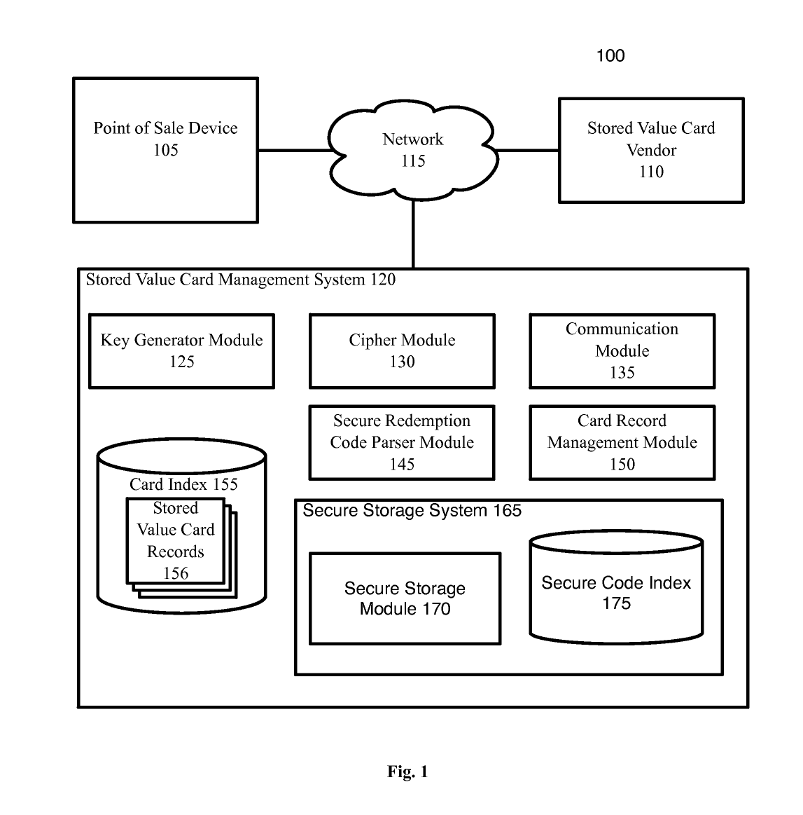

FIG. 1 is a block diagram depicting a stored value card management system 100 according to an exemplary embodiment. As depicted in FIG. 1, the system 100 includes network devices 105, 110, and 120 that are configured to communicate with one another via one or more networks 115.

Each network 115 includes a wired or wireless telecommunication means by which network devices (including devices 105, 110, and 120) can exchange data. For example, each network 115 can include a local area network (“LAN”), a wide area network (“WAN”), an intranet, an Internet, a mobile telephone network, or any combination thereof. Throughout the discussion of exemplary embodiments, it should be understood that the terms “data” and “information” are used interchangeably herein to refer to text, images, audio, video, or any other form of information that can exist in a computer-based environment.

Each network device 105, 110, and 120 includes a device having a communication module capable of transmitting and receiving data over the network 115. For example, each network device 105, 110, and 120 can include a server, desktop computer, laptop computer, tablet computer, smart phone, handheld computer, personal digital assistant (“PDA”), or any other wired or wireless, processor-driven device. In the exemplary embodiment depicted in FIG. 1, the network devices 105, 110, and 120 are operated by merchants, stored value card vendors, and stored value card management system operators, respectively.

A point of sale (POS) device 105 communicates information to third-party vendors for verification, such as credit card companies and the stored value card management system 120. The POS device 105 includes a reader capable of receiving and processing information from a gift card. Suitable readers include magnetic strip readers, QR code readers, near field communication (NFC) readers and similar means suitable for communicating payment information from a payment article, such as stored value card, to the POS device 105.

In one exemplary embodiment, the stored value card management system 120 comprises a key generator module 125, a cipher module 130, a communication module 135, a secure redemption code parser module 145, a card record management module 150, a card record index 155 containing card records 156, and a secure storage system 165, the secure storage system 165 further comprising a secure storage module 170 and a secure code index 175. The stored value card management system 120 communicates with POS devices 105 and servers of stored value card vendors 110 via a network 115. The communications module 135 communicates information between modules of the stored value card management system 120, as well as between the stored value card management system, POS devices 105 and gift card vendors 110. The key generator module 125 generates a key for encrypting and decrypting codes generated by the cipher module 130. Likewise, the cipher module 130 utilizes keys generated by the key generator 125 to generate codes for use in constructing a final stored value card redemption code. The secure storage system 165 stores the secure code component of the secure redemption code. The secure storage module converts secure codes into a secure storage version and stores the secure storage version in the secure code index 175. The secure redemption code parser module 145 receives secure redemption codes communicated from devices, such as POS devices 105, and parses them into their component parts for further validation as discussed in greater detail below. The card record management module 150 generates a card record 156 for each stored value card managed by the stored value card management system 120 and stores identifying information for each card in the card record 156.

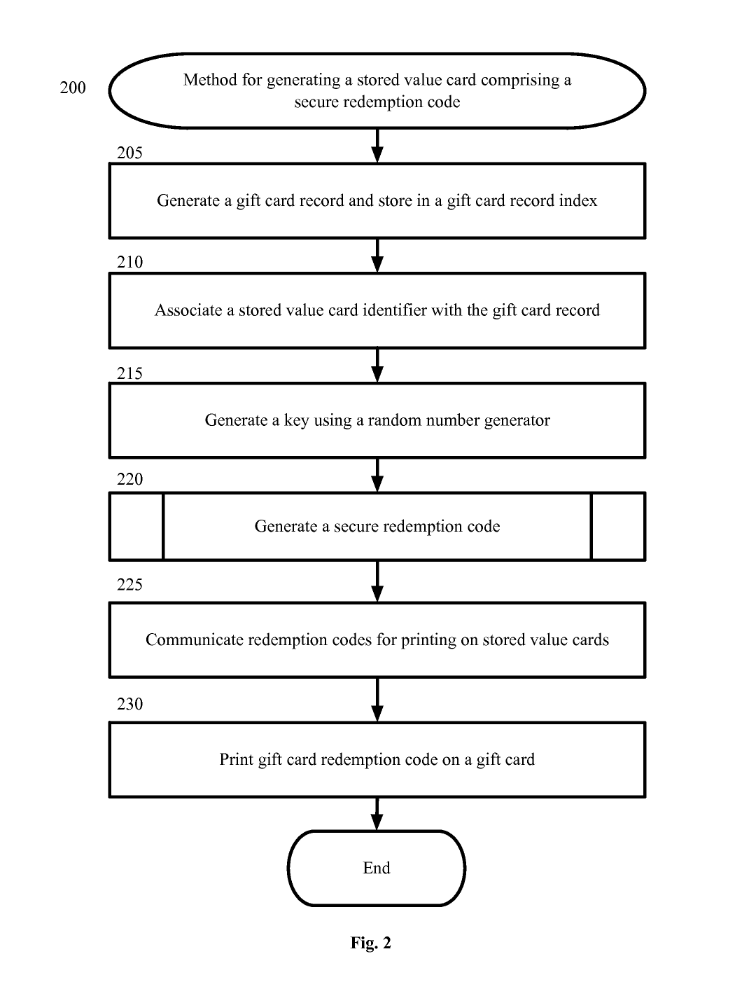

The stored value card management system 120 is described in more detail hereinafter with reference to the methods depicted in FIGS. 2-5.

### System Process

FIG. 2 is a block flow diagram depicting a method for generating stored value cards comprising secure redemption codes. The method 200 is described with reference to the components of FIG. 1.

Method 200 begins with block 205, where the card record management module 150 generates a card record 156 or set of card records 156 in the card record index 155.

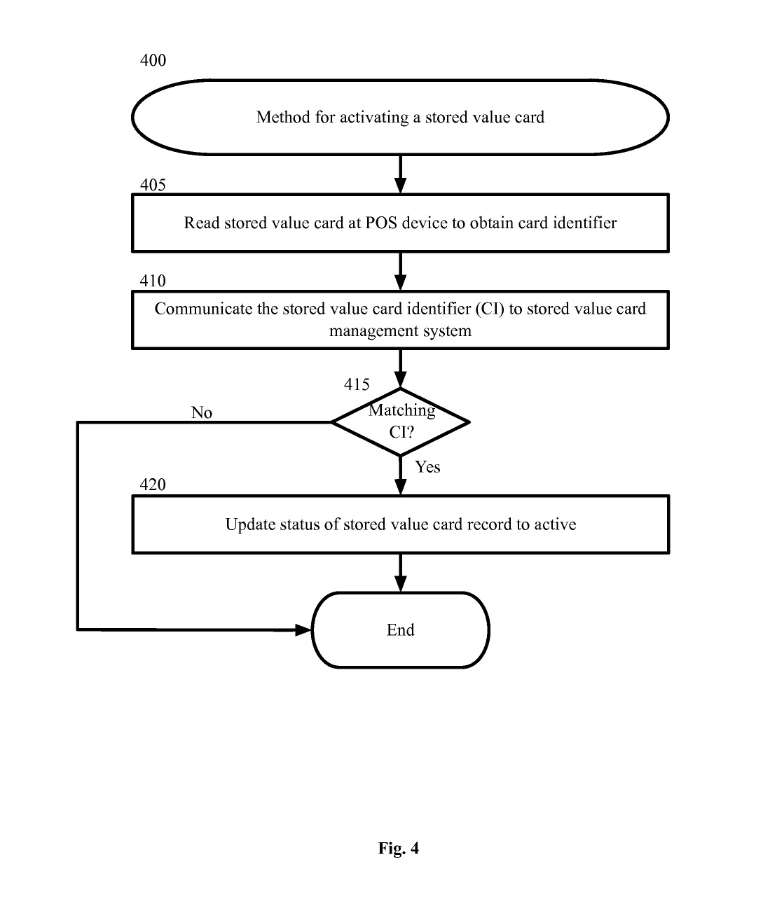

At block 210, the card record management module 150 associates a unique card identifier with each card record 156. The card identifier is used to look up information pertaining to the card record and to associate the card record with the physical card on which a given secure redemption code is printed. For example, a stored value card vendor 110 may use the card identifier to verify that the secure redemption code being printed on a given stored value card originated from the stored value card management system 120. The card identifier is further used to activate the stored value card as discussed in further detail hereinafter with reference to FIG. 4.

At block 215, the key generator module 125 uses a high entropy random number generator to generate a random number for use as a key. The random number generator may be a hardware random number generator, or a cryptographically secure pseudorandom number generator. In certain exemplary embodiments, the key may be any multiple of 32 bits starting with at least 128 bits. In one exemplary embodiment, the key is at least 512 bits. In another exemplary embodiment, the key is a 128 bit number. In one exemplary embodiment, a new key is generated for each new set of secure redemption codes.

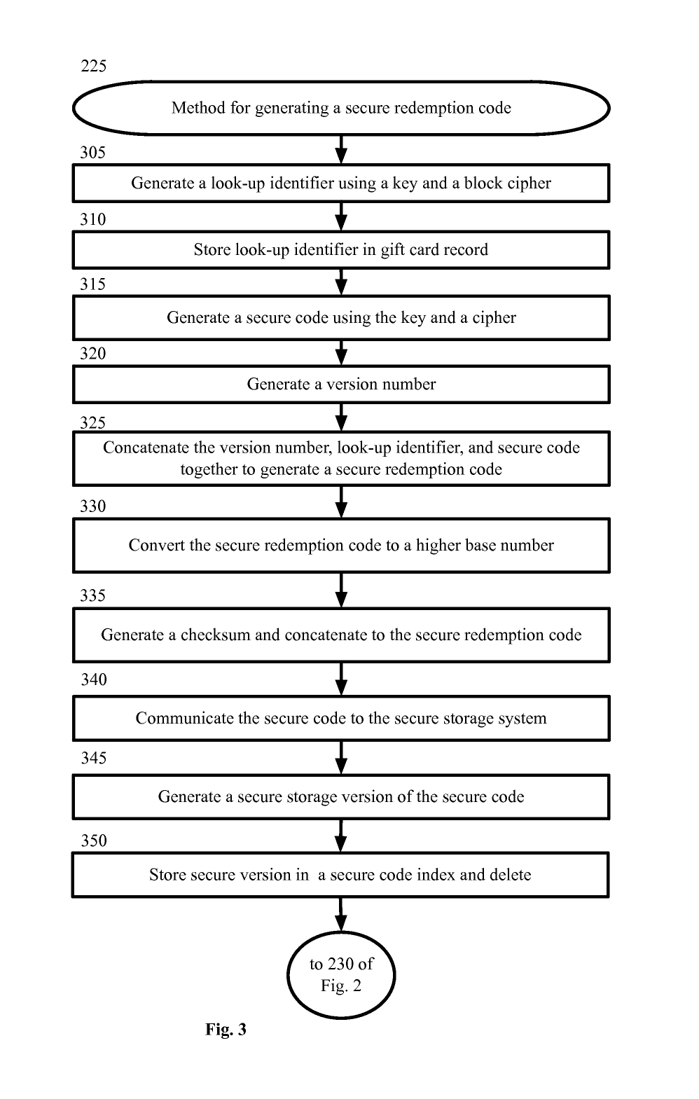

At block 220, the stored value card management system 120 generates a secure redemption code for printing on a designated area of the stored value card. Block 225 will be described in further detail hereinafter with reference to FIG. 3.

FIG. 3 is a block flow diagram depicting a method for generating a gift card redemption code as referenced in block 225 of FIG. 2. Thus, FIG. 3 describes a process 235 by which secure redemption codes are generated by the stored value card management system 120. The process 235 is described with reference to the components of FIG. 1.

At block 305, the cipher module 130 uses the key generated at block 215 of FIG. 2 and a cipher to generate a look-up identifier. The cipher may be a block cipher or a stream cipher. In one exemplary embodiment, the cipher is a symmetric block cipher. In yet another exemplary embodiment, the cipher is an AES block cipher. Other exemplary symmetric block ciphers include, but are not limited to, Blowfish, RCS, and Triple-DES. The look-up identifier may be a 32 to 128 bit number. In one exemplary embodiment, the look-up identifier is a 40 bit number.

At block 310, the card record management module 150 stores the look-up identifier generated at block 305 and associates it with a card record 156 in the card index 155.

At block 315, the cipher module 130 uses the key generated at block 305, or a second key generated using the same process as described at block 215, to generate a secure code using a cipher. The cipher may be the same cipher used in block 305 or a second cipher. Where the cipher is a second cipher, the second cipher may be a block cipher or a stream cipher. In on exemplary embodiment, the second cipher is a symmetric block cipher. In yet another exemplary embodiment, the second cipher is an AES block cipher. The secure code may be a 48 to 256 bit number. In one exemplary embodiment, the secure code is a 55 bit number.

At block 320, the card record management module 150 assigns each card record 156 a version number and stores the version number in the card record 156. The version number may be up to an 8 bit number.

At block 325, the card record management module 150 generates a secure redemption code by concatenating the version number, look-up identifier, and secure code, in binary form into a single string of binary numbers to generate a preliminary secure redemption code.

At block 330, the card record management module 150 converts the preliminary secure redemption code from its original base number to a higher base number to generate an converted secure redemption code. The converted secure redemption code may be converted to a base 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, or 36 number. In one exemplary embodiment, the converted secure redemption code is a base 34 number.

At block 335, the card record management module 150 generates a checksum of the converted secure redemption code, converts the resulting checksum value to the same base number as the converted secure redemption code, and concatenates the converted checksum value to the end of the converted secure redemption code to generate a final secure redemption code.

At block 340, the card record management module 150, communicates the secure code, in its binary form to the secure storage system. A copy of the secure code is not maintained outside the secure storage system 165.

At block 345, the secure storage module 170 generates a secure storage version of the secure code. In certain exemplary embodiments, the secure storage version of the secure code may be generated using a symmetric or asymmetric key. In another exemplary embodiment, the secure storage module 170 may generate a secure storage version of the secure code by generating a secure hash of the secure code. When generating a secure hash of the secure code, the secure storage module 170 may use a hash-based message authentication code comprising the hash key and a hash algorithm to generate the secure hash. Exemplary hash algorithms include, but are not limited to, GOST, HAVAL, MD2, MD4, MD5, PANAMA, RadioGatun, RIPEMD, RIPEMD-128/256, RIPEMD-160/320, SHA-0, SHA-1, SHA-256/224, SHA-512/384, Tiger(2)-192/160/128, WHIRLPOOL, BLAKE, Grøstl, JH, Keccak, and Skein. In one exemplary embodiment HMAC-SHA3 is used to generate the secure hash. In another exemplary embodiment, HMAC-SHA512 is used to generate the secure hash. The hash key or keys are maintained only by the secure storage module 170.

At block 350, the secure storage module 170 stores the secure storage version of the secure code in a secure code index 175. No identifying information is stored with the secure storage version of the secure code, such as look-up identifier or card record identifier, in the secure code index 175. In certain exemplary embodiments, the secure storage system 165 may be housed in a physically separate location from the rest of the stored value card management system 120. The access privileges to the secure storage system 165 are not the same as the access privileges to the rest of the stored value management system 120. The method then proceeds to block 225 of FIG. 2.

Returning to FIG. 2, at block 225, the communication module 135 communicates the card identifier and final secure redemption codes to a printer. The printer may be directly associated with the stored value card management system 120, or may be a stored value card vendor 110. In certain exemplary embodiments, where a stored value card vendor 110 is responsible for printing and distribution of the stored value cards, the stored value card vendor may assign each card a vendor identifier number. Accordingly, an optional cross-reference index may be created to associate vendor identifiers with the card identifiers and facilitate communication and card record look-up between the stored value card management system 120 and the stored value card vendor 110. The cross-reference index may be maintained as part of the stored value card management system 120, or may be maintained by the stored value card vendor 110.

At block 230, the secure redemption code is printed on a designated portion of the stored value card. There is no visible demarcation of the secure redemption code components on the card. After printing, a removable barrier, such as a scratch-off latex barrier, is applied over the secure redemption code. The card identifier is encoded on the card in a magnetic strip, a bar code, QR code, or other suitable electronic readable medium. The stored value cards comprising secure redemption codes are then ready for distribution to merchants for purchase (activation) and subsequent use to complete a payment transaction (redemption).

FIG. 4 is a block flow diagram depicting a method for activating a stored value card according to an exemplary embodiment. At block 405, a POS device 105 reads a stored value card, at the time of purchase, to obtain the card identifier. The appropriate type of card reader will depend on the type of stored value card and the manner in which the card identifier is encoded. In certain exemplary embodiments, the card identifier may also be visibly printed on the stored value card and entered manually be an operator of a POS device 105. In certain exemplary embodiments, a stored value card vendor 110 may assign and encode a vendor identifier in place of the card identifier.

At block 410, the POS device 105 communicates the card identifier to the stored value card management system 120 via the network 115. Where the stored value card vendor 110 has encoded a vendor identifier in place of a the card identifier, the vendor identifier is communicated first to the vendor 110 via the network 115 and then to the stored value card management system 120 after appropriate cross-referencing to determine the corresponding card identifier.

At block 415, the communication module 135 receives the card identifier and communicates this information to the card record management module 150. In certain exemplary embodiments, communications between the POS device 105 and the stored valued card vendor 110 may be encrypted. For example, the communications may be encrypted using standard asymmetric key encryption technologies. When encrypted, the communication module 135 decrypts the communication then communicates the decrypted information to the card record management module 150. The card record management module 150 then verifies the card identifier by cross-referencing the card index 155. If a corresponding card identifier is not found, the method 400 terminates. The communication module 135 may communicate a failure notification to the vendor 110 or POS device 105 based on the origin of the activation request. If a matching card identifier is found, the method proceeds to block 420.

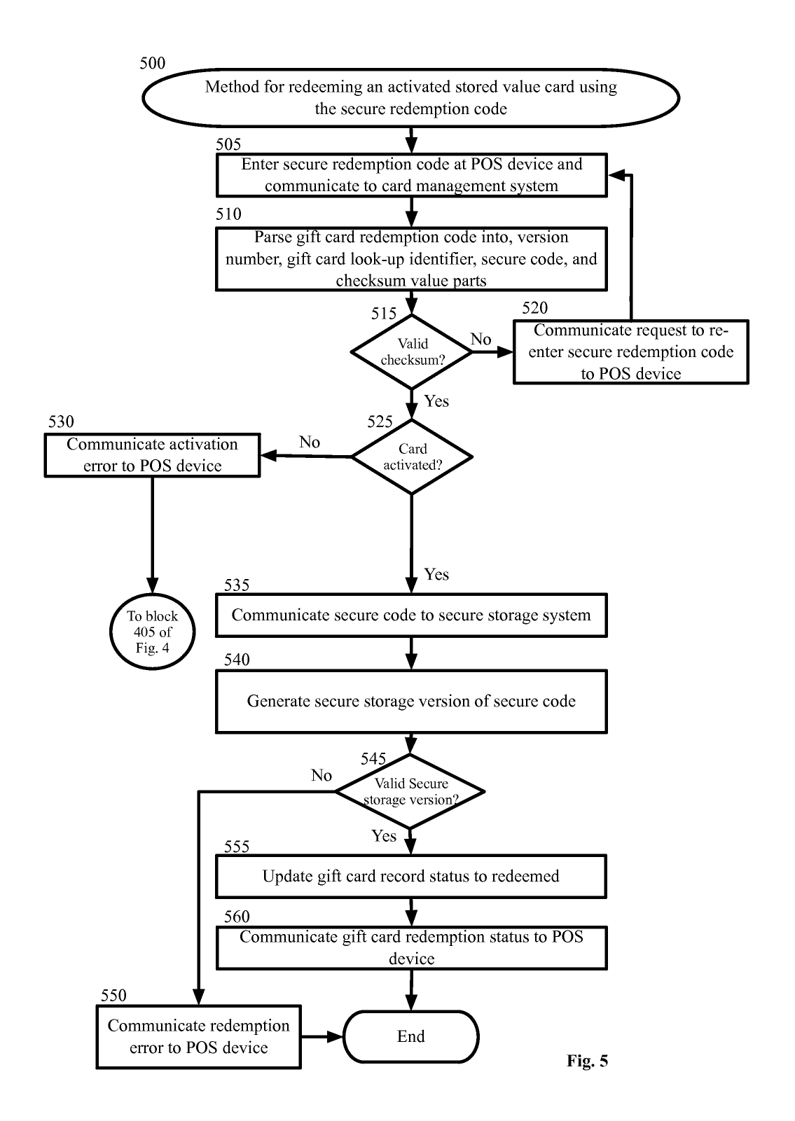

At block 420, the card record management module 150 updates the status of the corresponding card record 156 from inactive to active, and the communication module 135 communicates an activation notification to the stored value card vendor 110 or POS device 105 depending on the origin of the activation request. The method 400 then terminates. Upon successful activation, the stored value card may then be redeemed and used to complete a subsequent payment transaction. An exemplary method for redeeming an activated stored value card using a secure redemption code is described in further detail with reference to FIG. 5 below.

FIG. 5 is a block flow diagram depicting a method for redeeming an activated stored value card using a secure redemption code according to an exemplary embodiment. At block 505, the card holder or operator of the POS device 105 communicates the secure redemption code to the POS device 105. Alternatively, the communication module 135 of the stored value card management system 120 may host a web interface at which a card holder may enter the secure redemption code. For ease of reference, the remainder of the discussion will focus on entering the secure redemption code at a POS device 105. One of ordinary skill in the art will recognize that the process of entering and redeeming the card at a stored value card management system 120 hosted web interface and at POS device 105 follow the same essential steps. In certain exemplary embodiments, the secure redemption code is accessed by removing a removable barrier, such as a latex barrier, covering the portion of the stored value card on which the secure redemption code was printed. The POS device 105 then communicates the secure redemption code to the stored value card management system 120.

At block 510, the communication module 135 receives the secure redemption code from the POS device 105, and communicates the secure redemption code to the secure redemption code parser module 145. The secure redemption code parser module 145 parses the secure redemption code into its version number, look-up identifier, secure code, and checksum value component parts. In certain exemplary embodiments, the secure redemption code parser module 145 uses the version number to determine the order in which a particular set of secure redemption code component parts were concatenated together, or other details such as the number of bits allocated to the look-up identifier and secure code. The method then proceeds to block 515.

At block 515, the secure redemption code parser module 145 uses a checksum algorithm to verify the checksum value associated with the redemption code. In certain exemplary embodiments, the checksum verification could be done in the POS terminal or online browser. In one exemplary embodiment, the checksum algorithm is the Luhn algorithm. If the checksum algorithm does not validate the checksum value, the method proceeds to block 520.

At block 520, the communication module 135 communicates a request to re-enter the secure code to the POS device 105. The method then returns to block 505.

Returning to block 515, if the secure redemption code parser module 145 verifies the checksum value, the method proceeds to block 525.

At block 525, the secure redemption code parser module 145 communicates the look-up identifier to the card record management module 150. The card record management module 150 uses the look-up identifier to verify the status of the corresponding card record 156 in the card record index 155. If the status of the corresponding card record 156 is not “active”, the method proceeds to block 530.

At block 530, the communication module 135 communicates an activation error to the POS device 105. The method cannot proceed without proper activation of the stored value card. In certain exemplary embodiments, the activation error may direct the card holder to block 405 of FIG. 4 to complete the required activation of the stored value card.

Returning to block 525, if the status of the corresponding card record 156 is “active” the method proceeds to block 535.

At block 535, the card record management module 150 communicates the secure code to the secure storage module 170 of the secure storage system 165. The method then proceeds to block 540.

At block 540, the secure storage module 170 generates the corresponding secure storage version of the secure code using the same process to originally generate the secure storage version at block 325 of FIG. 3. The method 500 then proceeds to block 545.

At block 545, the secure storage module 170 verifies the secure code by searching the secure hash index 175 for a matching secure storage version. If a matching secure storage version is not found in the secure index 175, the method proceeds to block 550.

At block 550, the communication module 135 communicates a validation error to the POS device 105 and the method terminates.

Returning to block 545, if the secure storage module 170 identifies a matching secure storage version in the secure index 170, the method proceeds to block 555. At block 555, the card record management module 150 updates the corresponding card record to indicate the redemption status of the card as redeemed. Method 500 then proceeds to block 560.

At block 560, the communication module 135 communicates a card redemption notification to the POS device 105. In certain exemplary embodiments, the stored value card management system may be in communication with a payment processing system. If so, the communication module 135 may communicate the validation notification directly to the payment processing system so that further processing of the transaction can be completed.

### General

One or more aspects of the exemplary embodiments may include a computer program that embodies the functions described and illustrated herein, wherein the computer program is implemented in a computer system that comprises instructions stored in a machine-readable medium and a processor that executes the instructions. However, it should be apparent that there could be many different ways of implementing the exemplary embodiments in computer programming, and the exemplary embodiments should not be construed as limited to any one set of computer program instructions. Further, a skilled programmer would be able to write such a computer program to implement an embodiment based on the appended flow charts and associated description in the application text. Therefore, disclosure of a particular set of program code instructions is not considered necessary for an adequate understanding of how to make and use the exemplary embodiments. Moreover, any reference to an act being performed by a computer should not be construed as being performed by a single computer as more than one computer may perform the act.

The exemplary systems, methods, and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments of the invention have been described above in detail, the description is merely for purposes of illustration. Various modifications of, and equivalent blocks and components corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

1. A computer-implemented method for redeeming value from an activated stored value card using a secure redemption code, comprising:
receiving, at a computer, a request to redeem value from a stored value card, the request comprising a secure redemption code encoded on the stored value card, the secure redemption code comprising a look-up identifier component and a secure code component concatenated together as a single string, the look-up identifier having a matching look-up identifier in a corresponding card record in a card record index, the corresponding card record indicating a status of the stored value card as active or inactive;
parsing, by the computer, the secure redemption code into at least the look-up identifier component and the secure code component;
verifying, by the computer, that the stored value card is activated by checking an activation status in the stored value card record in the card record index using the look-up identifier;
generating, by the computer, a secure storage version of the secure code component by generating a hash of the secure code component;
validating, by the computer, the secure code by searching a secure code index comprising a matching secure storage version of the secure code component previously generated and stored in the secure code index when the secure code component was initially generated, the secure code index being separate and distinct from the card record index; and
authorizing, by the computer, the redemption request based on identification of a matching secure storage version of the secure code in the validating step.

2. The method of claim 1, wherein generating a secure storage version of the secure code comprises encrypting the secure code with a symmetric key.

3. The method of claim 1, wherein generating a secure storage version of the secure code comprises generating a hash of the secure code using a hash key and a hash algorithm.

4. The method of claim 1, further comprising determining, by the computer, prior to authorizing the redemption request, an activation status of the stored value card, wherein an activation status of active indicates the card can be redeemed;

5. The method of claim 1, wherein the secure redemption code is further parsed into a version number and a checksum value.

6. The method of claim 5, wherein the checksum value is validated using a checksum algorithm prior to identifying the matching stored value card record, and wherein failure to validate the checksum value results in generation of a request to re-renter the secure redemption code.

7. The method of claim 1, wherein the secure redemption code is at least a 100 bit number.

8. The method of claim 7, wherein the secure redemption code is converted into a base 34 number.

9. The method of claim 1, wherein the key is generated using a high entropy random number generator.

10. The method of claim 1, wherein the secure code index is located in a physically distinct location from the card record index.

11. The method of claim 1, wherein an access privilege to the secure code index is different from an access privilege to the card record index.

12. A computer program product, comprising:
a computer-readable medium having computer-readable program code embodied therein for redeeming an activated stored value card using a secure redemption code, the computer-readable medium comprising:
computer-readable program code for receiving a secure redemption code encoded on a stored value card the secure redemption code comprising a look-up identifier and a secure code concatenated together to form a single string, the look-up identifier and secure code independently generated using a cipher and a key prior to being concatenated together that is not stored in or associated with the stored value card record in the card record index, the look-up identifier having a matching look-up identifier in a corresponding card record in a card record index, the corresponding card record indication a status of the stored value card as active or inactive;
computer-readable program code for parsing the secure redemption code into at least the look-up identifier and the secure code;
computer-readable program code for identifying a matching stored value card record in the card record index using the look-up identifier;
computer-readable program code for generating a secure storage version of the secure code component by generating a hash of the secure code component;
computer-readable program code for validating the secure code by searching a secure code index comprising a matching secure storage version of the secure code component previously generated and stored in the secure code index when the secure code component was initially generated, the secure code index being separate and distinct from the card record index; and
computer-readable program code for authorizing the redemption request based on identification of a matching secure storage version in the validating step.

13. The computer program product of claim 12, wherein generating a secure storage version of the secure code comprises encrypting the secure code with a symmetric key.

14. The computer program product of claim 12, wherein generating a secure storage version of the secure code comprises generating a hash of the secure code using a hash key and a hash algorithm.

15. The computer program product of claim 12, further comprising computer readable program code for determining, prior to authorizing the redemption request, an activation status of the stored value card, wherein the activation status of active indicates the card can be redeemed.

16. The computer program product of claim 12, wherein the secure redemption code is further parsed into a version number and a checksum value.

17. The computer program product of claim 16, wherein the computer program product further comprises computer-readable program code for validating the checksum value.

18. The computer program product of claim 12, wherein the secure redemption code is at least a 100 bit number.

19. The computer program product of claim 18, wherein the secure redemption code is converted into a base 34 number.

20. The computer program product of claim 12, wherein the key is generated using a high entropy random number generator.

21. A system for managing stored value cards comprising:
a storage device; and
a processor communicatively coupled to the storage device, wherein the processor executes application code instructions that are stored in the storage device and that cause the system to:
receive a secure redemption code encoded on a stored value card, the secure redemption code comprising a look-up identifier and a secure code concatenated together to appear on the stored value card as a single string, the look-up identifier having a matching look-up identifier in a corresponding card record in a card record index, the card record indicating a status of the stored value card as active or inactive;
parse the secure redemption code into at least the look-up identifier and the secure code;
identify a matching stored value card record in the card record index using the look-up identifier;
generate a secure storage version of the secure code component by generating a hash of the secure card component;
validate the secure code by searching a secure code index comprising a matching secure storage version of the secure code component previously generated and stored in the secure code index when the secure code component was initially generated, the secure code index being separate and distinct from the card record index; and
authorize the redemption request based on identification of a matching secure storage version of the secure code.

22. The system of claim 21, wherein the secure storage version of the secure code is generated by encrypting the secure code with a symmetric key.

23. The system of claim 22, wherein the secure code is generated by generating a hash of the secure code using a hash key and hash algorithm.

24. The system of claim 21, wherein the secure redemption code is further parsed into a version number and a checksum value.
